(19) United States
(12) Patent Application Publication
(10) Pub. No.: US 2008/0316166 A1
(43) Pub. Date: Dec. 25, 2008

(54) Plane Light Device for Liquid Crystal Display and Driving Method of the same

(76) Inventors: Jin-Chyuan HUNG, Hsinchu City (TW); Yung-Hsiang Chao, Jhonghe City (TW); Yui-Shin Fran, Hsinchu City (TW); Chun-Hui Tsai, Hsinchu City (TW)

Correspondence Address: HDSL, P.O. BOX 220746, CHANTILLY, VA, 20153-0746, US

(21) Appl. No.: 12/025,116

(22) Filed: Feb. 4, 2008

(30) Foreign Application Priority Data
Jun. 22, 2007 (TW) 096122457

(51) Int. Cl. G09G 3/36; G02F 1/13357

(52) U.S. Cl. 345/102; 349/69

(57) ABSTRACT

A method of driving plane light is used in a liquid crystal display. A plane light device includes a first substrate, a frame, a second substrate, a fluorescent layer, a plurality of spacers, and an outer electrode layer. A plane chamber is formed between the first substrate and the second substrate to filling mixed gases therein. The outer electrode layer includes a plurality of independent electrode pairs. The mixed gas is discharged by the fluorescent layer to produce a plurality of corresponding light emitting regions after driving respectively the plurality of electrode pairs. The plurality of light emitting regions have interval lines parallel or perpendicular to scanning lines of the liquid crystal display. The plurality of light emitting regions are opened synchronously, in series or alternately. The image blurry phenomenon displayed in the LCDs will be effectively improved caused by slow response of LCD's cells.

### 1. FIELD OF THE INVENTION

The present invention relates to plane light devices for liquid crystal displays and driving methods thereof, more specifically, to a plane light device for a liquid crystal display and a driving method thereof, which improves phenomenon of blurry images produced by overlapping video data of the liquid crystal display.

### 2. DESCRIPTION OF THE RELATED ART

Liquid crystal displays are developed as a main technology of display devices. The main principle thereof is that liquid crystal molecule has a twisting character, and light pass through twisting angles of the light crystal molecule to produce different transmittance luminance, and pass through three predistributing RGB color filters to display images.

Since the liquid crystal molecule itself cannot emit light, the liquid crystal display must have a light device to provide the light such that the liquid crystal display may operate normally. A conventional light device generally includes a cold cathode tube for providing linear light and a light guide plate cooperates with the cold cathode tube. The cold cathode tube provides the linear light, and the light guide plate transfers the linear light to plane light for the liquid crystal display.

Since the displaying area of the LCD grows, another conventional plane light device has been developed. The conventional plane light device fills mixed gas into a plane chamber, covers a fluorescent material in the plane chamber, and provides an electrical field by using an electrode of the plane chamber to discharge the mixed gas for providing the plane light for the light crystal display. The conventional plane light device needs not the light guide plate and can eliminate dark regions produced in the large size liquid crystal display, which cooperates with the code cathode tube.

However, when the light crystal display displays the images, if the light device maintains to emit the light, blurry images will be produced since the video data overlaps. This influences greatly the display quality and needs to be solved immediately.

What is needed is a plane light device which can solve the above problems.

### BRIEF SUMMARY

The present invention uses a decaying element between microphones and ears to decay wanted environmental noise and music or broadcasting.

A plane light device used in a liquid crystal display in accordance with a preferred embodiment of the present invention, includes a first substrate, a fluorescent layer arranged on the first substrate, a frame arranged at a periphery of the first substrate, a second substrate connecting to the frame to form a plane chamber arranged between the first substrate and the second substrate for filling mixed gas therein, a plurality of spacers arranged between the first substrate and the second substrate, and an outer electrode layer arranged another surface of the first substrate opposite to the plane chamber. The outer electrode layer includes a plurality of independent electrode pairs, and the mixed gas is discharged by the fluorescent layer to produce a plurality of corresponding light emitting regions after driving respectively the plurality of electrode pairs.

The plane light device further includes an insulated layer arranged another surface of the first substrate opposite to the outer electrode layer and covering the outer electrode layer to protect the outer electrode layer. The insulated layer is an insulated adhesive tape.

The plane chamber is a communicated plane chamber, and the mixed gas has no hydrargyrum.

The plurality of electrode pairs are driven synchronously, in series or alternately to open the light emitting regions synchronously, in series or alternately. When the image data is not inputted, the corresponding light emitting region closes to reduce probability for displaying blurry images by overlapping the image data of the liquid crystal display.

A method driving plane light in accordance with another preferred embodiment of the present invention is used to drive a plane light device used in a liquid crystal display. The plane light device includes a plurality of light emitting regions, and the plurality of light emitting regions have interval lines parallel or perpendicular to scanning lines of the liquid crystal display. The method includes following steps: closing the plurality of light emitting regions at an original point of time of inputting predetermined image data of the liquid crystal display; opening the plurality of light emitting regions in series during time of inputting real image data of the liquid crystal display; and closing the plurality of light emitting regions at finishing the time of inputting real image data of the liquid crystal display.

Each following light emitting region is opened synchronously after closing each last light emitting region.

Opening periods of the plurality of light emitting regions have overlapped parts.

The each opening period of the each light emitting region is same.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, partial cross-sectional view of a plane light device of a first embodiment of the present invention;

FIG. 2 is a schematic view of a liquid crystal display corresponding to the plane light device having a plurality of light emitting regions of the first embodiment of the present invention;

FIG. 3 is a schematic, partial cross-sectional view of a plane light device of a second embodiment of the present invention;

FIG. 4 is a schematic view of a driving clock of a method of driving plane light of the present invention;

FIG. 5 is a schematic view of a driving clock of the method of driving plane light in accordance with a third preferred embodiment of the present invention; and

FIG. 6 is a schematic view of a driving clock of the method of driving plane light in accordance with a fourth preferred embodiment of the present invention.

### DETAILED DESCRIPTION

Reference will now be made to the drawings to describe a preferred embodiment of the present plane light device, in detail.

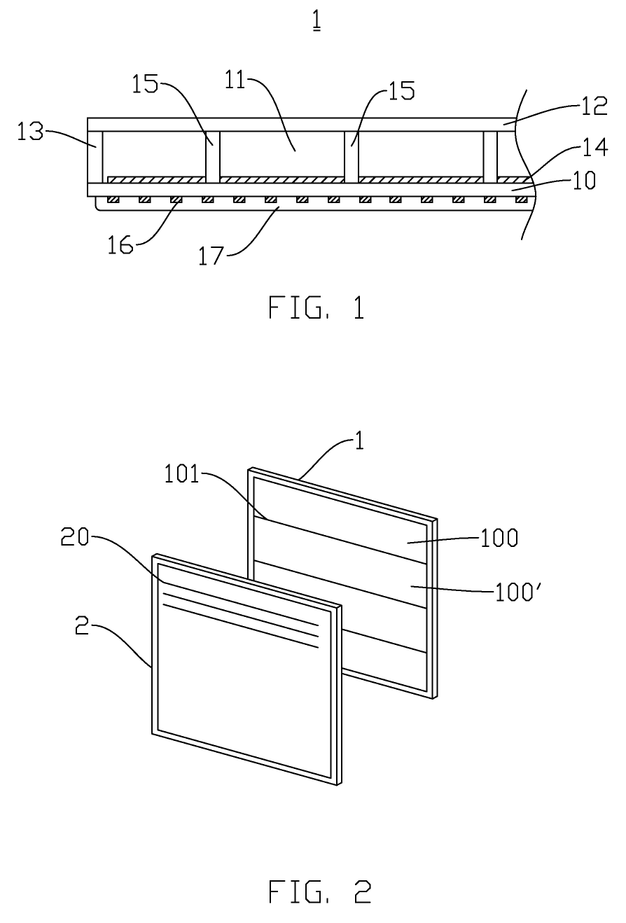

Referring to FIG. 1, a plane light device 1 in accordance with a first preferred embodiment of the present invention is shown. The plane light device 1 includes a first substrate 10, a fluorescent layer 14, a frame 13, a second substrate 12, a plurality of spaces 15, an outer electrode layer 16 and an insulated layer 17. Preferably, the first substrate 10 is a glass substrate. The fluorescent layer 14 is arranged on the first substrate 10 and is manufactured by covering fluorescent powder on the first substrate 10. The frame 13 is arranged at the periphery of the first substrate 10, and the periphery of the second substrate 12 connects with the frame 13 to form a plane chamber 11 between the first substrate 10 and the second substrate 12. The frame 13 is used to support the first substrate 10 and the second substrate 12, and the plane chamber 11 is a communicated plane chamber to fill mixed gas therein. Preferably, the mixed gas has no hydrargyrum. The plurality of spacers 15 are arranged between the first substrate 10 and the second substrate 12 to support the first substrate 10 and the second substrate 20 and maintain space of the plane chamber 11. The outer electrode layer 16 is arranged on the substrate 10 opposite to the plane chamber 11. The insulated layer 17 is arranged on the outer electrode layer 16 opposite to the first substrate 10 and covers the outer electrode layer 16 to protect the outer electrode layer 16. Preferably, the insulated layer 17 is an insulated adhesive tape.

The outer electrode layer 16 includes at least a plurality of independent electrode pairs (not shown). The plurality of electrode pairs are driven respectively and the driving power are transmitted through a dielectric barrier (for example, the first substrate 10 made of glass material) to discharge the mixed gas activated by the fluorescent layer 14 corresponding to the plurality of electrode pairs since the plurality of electrode pairs are arranged on the exterior of the plane chamber 11. Therefore, a plurality of corresponding light emitting regions 100, 100′ are produced to emit light out of the second substrate 12. Referring to FIG. 2, the plurality of light emitting regions 100, 100′ has a plurality of interval lines 101 arranged therebetween. The plurality of interval lines 101 are parallel to scanning lines 20 of the liquid crystal display 2 to divide the whole plane light device 1 into the plurality of parallel light emitting regions 100, 100′. In this exemplary embodiment, the plane light device 1 is divided into four light emitting regions. The amount of the light emitting regions are related to the size of the liquid crystal display 2, and the plurality of electrode pairs are distributed and configured by the need of the light emitting regions. The interval lines 101 between the plurality of light emitting regions 100, 100′ may be also designed to be perpendicular to the scanning lines 20 of the liquid crystal display 2 for corresponding to the configuration of the scanning lines of the liquid crystal display (not shown).

The plurality of electrode pairs are driven synchronously, in series or alternately to make the plurality of light emitting regions 100, 100′ emit synchronously, in series or alternately. If the time of closing or opening the plurality of light emitting regions correspond to the time of inputting data signals of the liquid crystal display 2, and the corresponding light emitting regions close when the data signals of the liquid crystal display 2 produce overlapping images, the overlapping images can be avoided. Therefore, the amount of the plurality of light emitting regions is corresponding to the data transmitting amount and time of the liquid crystal display 2. For example, this exemplary embodiment includes the four light emitting regions.

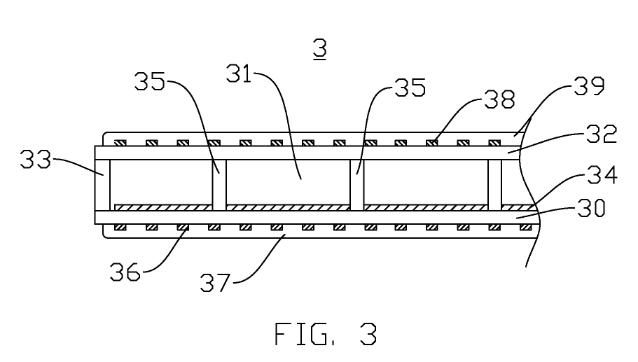

Referring to FIG. 3, a plane light device in accordance with a second preferred embodiment of the present invention is shown. The plane light device 3 also includes a first substrate 30, a fluorescent layer 34, a frame 43, a second substrate 32, a plurality of spaces 35, and so on. The plane light device 3 is similar to that of the first preferred embodiment, for example, a plane chamber 31 is formed between the first substrate 30 and the second substrate 32, and the plane chamber 31 is a communicated plane chamber to fill mixed gas therein, except that the plane light device 3 further includes a first outer electrode layer 36, a second outer electrode layer 38, a first insulated layer 37, and a second outer insulated layer 39. The first outer electrode layer 36 is arranged on another surface of the first substrate 30 opposite to the plane chamber 31. The second outer electrode layer 38 is arranged on another surface of the second substrate 32 opposite to the plane chamber 31. The first insulated layer 37 is arranged on another surface of the first outer electrode layer 36 opposite to the first substrate 30, and covers the first outer electrode layer 36 to protect the first outer electrode layer 36. The second outer insulated layer 39 is arranged on another surface of the second outer electrode layer 38 opposite to the second substrate 32, and covers the second outer electrode layer 38 to protect the second outer electrode layer 38. Preferably, the first insulated layer 37 and the second insulated layer 39 are respectively an insulated adhesive tape, and the second insulated layer 39 is a transparent insulated adhesive tape.

The first outer electrode layer 36 and the second outer electrode layer 38 respectively include at least a plurality of independent electrodes (not shown) to form a plurality of independent electrode pairs (not shown). The plurality of electrode pairs are driven respectively and the driving power are transmitted through a dielectric barrier (for example, the first substrate 30 and the second substrate 32 made of glass material, etc.) to discharge the mixed gas activated by the fluorescent layer 34 corresponding to the plurality of electrode pairs since the plurality of electrode pairs are arranged on the exterior of the plane chamber 11. Therefore, a plurality of corresponding light emitting regions 100, 100′ are produced to emit light out of the second substrate 12. Referring to FIG. 2, the plurality of light emitting regions 100, 100′ has a plurality of interval lines 101 arranged therebetween. The plurality of interval lines 101 are parallel to scanning lines 20 of the liquid crystal display 2 to divide the whole plane light device 1 into the plurality of parallel light emitting regions 100, 100′. In this exemplary embodiment, the plane light device 1 is divided into four light emitting regions. The amount of the light emitting regions are related to the size of the liquid crystal display 2, and the plurality of electrode pairs are distributed and configured by the need of the light emitting regions. The interval lines 101 between the plurality of light emitting regions 100, 100′ may be also designed to be perpendicular to the scanning lines 20 of the liquid crystal display 2 for corresponding to the configuration of the scanning lines of the liquid crystal display (not shown).

The present invention also discloses a driving method of plane light to drive a plane light device of a liquid crystal display. The plane light device includes a plurality of light emitting regions distributed parallel. Interval lines of the plurality of the light emitting regions are parallel or perpendicular to scanning lines of the liquid crystal display. The driving method includes the following steps.

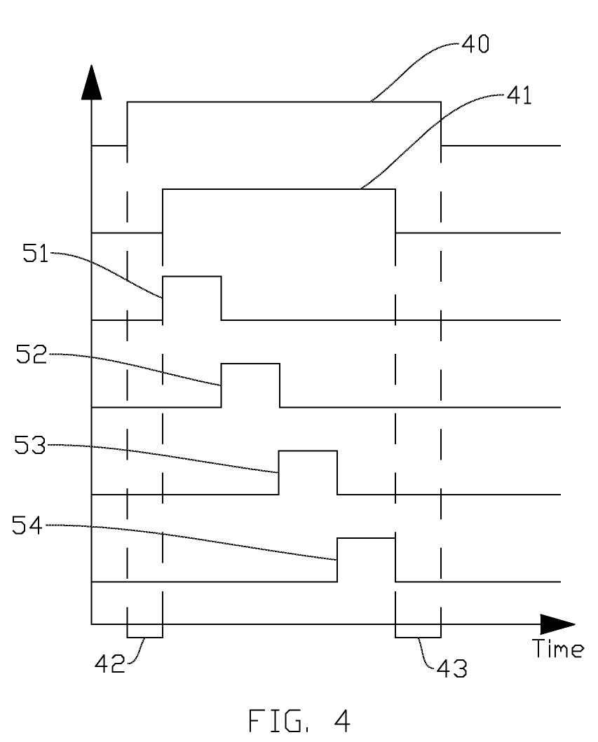

Firstly, referring to FIG. 4, the plurality of light emitting regions are closed during time 40 of inputting predetermined image data of the liquid crystal display, that is, no any light emitting regions are opened at the first interval period 42, wherein the time 40 of inputting predetermined image data is a standard of a general liquid crystal display. For example, if the liquid crystal display has a frequency of 120 Hz, the time 40 of inputting image predetermined data is 8.3 ms, and the first interval period 42 (that is, the time of having no any light emitting regions opened) is 0.052 ms. Therefore, since no any real image data are input during the first interval period 42, no any light emitting regions are opened, thus the probability for displaying error images is decreased.

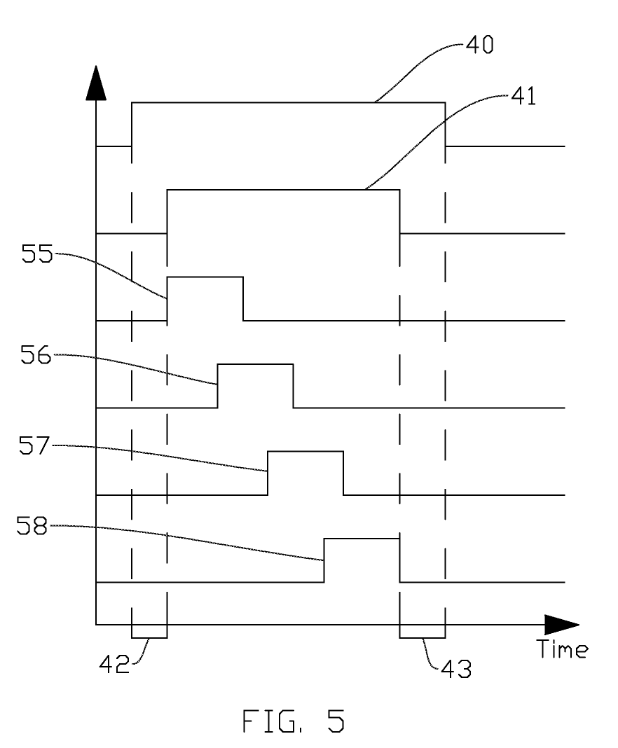

Next, the plurality of light emitting regions are opened in series during the time 41 of inputting real image data of the liquid crystal display, wherein the time 41 of inputting real image data is an interval of inputting real image data of the liquid crystal display. In fact, the original point of the time 41 of inputting real image data is later than that of the time 40 of the predetermined image data to ensure the image data to be displayed early for avoiding to display error images since the image data are inputted early. In this exemplary embodiment, the plane light device includes the four parallel light emitting regions, and a plurality of opening periods 51, 52, 53, 54 are opened in series. That is, each following light emitting region is opened synchronously at each last light emitting region is closed. For example, if the time 41 of inputting real image data of the liquid crystal display is 7.92 ms, each light emitting region has a same interval period of being opened, and the same interval period is 1.98 ms. Referring to FIG. 5, a plane light device 4 in accordance with a third preferred embodiment of the present invention is shown. The plane light device 4 also includes four parallel light emitting regions. Opening periods 55, 56, 57, 58 of the plurality of light emitting regions have overlapped parts. That is, each following light emitting region is opened before each last light emitting region is closed completely. The above embodiments correspond to the inputting image data and the amount of the light emitting region.

Lately, the whole plurality of light emitting regions are closed at finishing the time 41 of inputting real image data of the liquid crystal display, that is, no any light emitting regions are opened during the second interval period 43. For example, the second interval period 43 (the interval period having no any light emitting regions opened) is 0.052 ms. Stored current is discharged by displaying capacitor of the liquid crystal display during the second interval period 43, the probability for displaying error images is decreased since no any light emitting regions are opened.

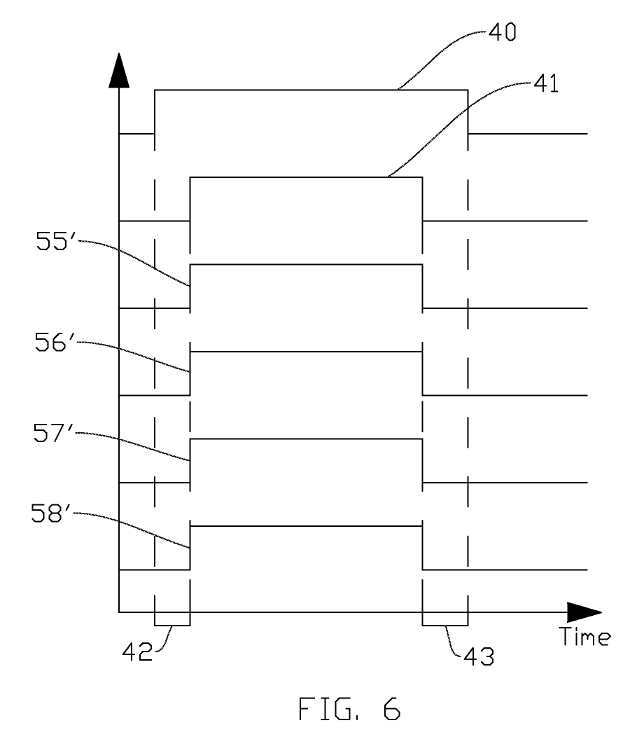

Referring to FIG. 6, opening periods 55′ 56′ 57′ 58′ of the light emitting regions in FIG. can be designed into the time 41 of inputting real image data synchronous (opening and closing synchronously). That is, the plurality of electrodes are driven synchronously to achieve the same effect through real design and test.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A plane light device used in a liquid crystal display, comprising:
a first substrate;
a fluorescent layer arranged on the first substrate;
a frame arranged at a periphery of the first substrate;
a second substrate connecting to the frame to form a plane chamber arranged between the first substrate and the second substrate for filling mixed gas therein; and
an outer electrode layer arranged another surface of the first substrate opposite to the plane chamber, the outer electrode layer including a plurality of independent electrode pairs, the mixed gas being discharged by the fluorescent layer to produce a plurality of corresponding light emitting regions after driving respectively the plurality of electrode pairs.

2. The plane light device as claimed in claim 1, further comprising a plurality of spacers arranged between the first substrate and the second substrate.

3. The plane light device as claimed in claim 1, further comprising an insulated layer arranged another surface of the first substrate opposite to the outer electrode layer and covering the outer electrode layer to protect the outer electrode layer.

4. The plane light device as claimed in claim 3, wherein the insulated layer is an insulated adhesive tape.

5. The plane light device as claimed in claim 1, wherein the plane chamber is a communicated plane chamber, and the mixed gas has no hydrargyrum.

6. The plane light device as claimed in claim 1, wherein the plurality of electrode pairs are driven synchronously, in series or alternately.

7. The plane light device as claimed in claim 1, wherein the plurality of light emitting regions have interval lines parallel to scanning lines of the liquid crystal display.

8. The plane light device as claimed in claim 1, wherein the plurality of light emitting regions have interval lines perpendicular to scanning lines of the liquid crystal display.

9. A plane light device used in a liquid crystal display, comprising:
a first substrate;
a fluorescent layer arranged on the first substrate;
a frame arranged at a periphery of the first substrate;
a second substrate connecting to the frame to form a plane chamber arranged between the first substrate and the second substrate for filling mixed gas therein; and
a first outer electrode layer arranged another surface of the first substrate opposite to the plane chamber;
a second outer electrode layer arranged another surface of the second substrate opposite to the plane chamber;
wherein the first outer electrode layer and the second electrode layer including respectively a plurality of independent electrode to form a plurality of independent electrode pairs, the mixed gas being discharged by the fluorescent layer to produce a plurality of corresponding light emitting regions after driving respectively the plurality of electrode pairs.

10. The plane light device as claimed in claim 9, further comprising a plurality of spacers arranged between the first substrate and the second substrate.

11. The plane light device as claimed in claim 9, further comprising a first insulated layer arranged another surface of the first outer electrode layer opposite to the first substrate and covering the outer electrode layer to protect the outer electrode layer.

12. The plane light device as claimed in claim 9, further comprising a second insulated layer arranged another surface of the second outer electrode layer opposite to the second substrate and covering the outer electrode layer to protect the outer electrode layer.

13. The plane light device as claimed in claim 11, wherein the insulated layer is one of a transparent insulated adhesive tape and an insulated adhesive tape.

14. The plane light device as claimed in claim 12, wherein the insulated layer is one of a transparent insulated adhesive tape and an insulated adhesive tape.

15. The plane light device as claimed in claim 9, wherein the plane chamber is a communicated plane chamber, and the mixed gas has no hydrargyrum.

16. The plane light device as claimed in claim 9, wherein the plurality of electrode pairs are driven synchronously, in series or alternately.

17. The plane light device as claimed in claim 9, wherein the plurality of light emitting regions have interval lines parallel to scanning lines of the liquid crystal display.

18. The plane light device as claimed in claim 9, wherein the plurality of light emitting regions have interval lines perpendicular to scanning lines of the liquid crystal display.

19. A method of driving plane light to driving a plane light device used in a liquid crystal display, wherein the plane light device including a plurality of light emitting regions, the method comprising:
closing the plurality of light emitting regions at an original point of time of inputting predetermined image data of the liquid crystal display;
opening the plurality of light emitting regions in series during time of inputting real image data of the liquid crystal display; and
closing the plurality of light emitting regions at finishing the time of inputting real image data of the liquid crystal display.

20. The method as claimed in claim 19, wherein each following light emitting region is opened synchronously after closing each last light emitting region.

21. The method as claimed in claim 19, wherein opening periods of the plurality of light emitting regions have overlapped parts.

22. The method as claimed in claim 19, wherein each opening period of the each light emitting regions are same.

23. The plane light device as claimed in claim 19, wherein the plurality of light emitting regions have interval lines parallel to scanning lines of the liquid crystal display.

24. The plane light device as claimed in claim 19, wherein the plurality of light emitting regions have interval lines perpendicular to scanning lines of the liquid crystal display.
